(19) United States
(12) Patent Application Publication
(10) Pub. No.: US 2005/0155036 A1
(43) Pub. Date: Jul. 14, 2005

(54) Application server addressing

(75) Inventors: Vesa Tiainen, Vantaa (FI); Seppo Huotari, Espoo (FI); Kirsi Rotsten, Nurmijarvi (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/871,326

(22) Filed: Jun. 21, 2004

(30) Foreign Application Priority Data
Dec. 19, 2003 (EP) 03029377.3

(51) Int. Cl. G06F 3/00; G06F 9/44; H04Q 7/24; G06F 9/46; G06F 13/00; H04Q 7/20

(52) U.S. Cl. 719/310; 719/313

(57) ABSTRACT

Method and system addressing a serving entity in a communication network are disclosed. On the basis of a service address, a user registration message for a service is sent to a serving entity group having a plurality of serving entities, each of which is arranged to support the service. Upon receiving a message acknowledging the sent registration message and including an address of a serving entity selected from the serving entity group for supporting the service, the address of the selected serving entity is included into an address table comprising service addresses and serving entity addresses.

### FIELD OF THE INVENTION

The present invention relates to 3GPP (Third Generation Partnership Project) AS (Application Server) architecture. In particular, the invention relates to addressing a serving entity such as an application server in a communication network, e.g. an IP (Internet Protocol) subsystem such as an IMS (IP Multimedia core network Subsystem).

### BACKGROUND OF THE INVENTION

FIG. 11 shows signaling for third party registration at an application server group or cluster comprising application server nodes (AS nodes) AS1 to AS4 in an IMS.

A serving call state control function S-CSCF provides session control for a user equipment (not shown). A home subscriber server HSS comprises an HLR (Home Location Register) and UMS (User Mobility Server) and provides for user identification and access and service authorization. The AS nodes A1 to A4 offer value added IP multimedia services and host and execute services.

It is assumed that all AS nodes A1 to A4 belonging to the AS cluster support a service_x. In case of a subscriber registration, the S-CSCF receives via a Cx interface filter criterion (FC) data, i.e. initial FC data (iFC data), from the HSS which has included the address of an application server into the iFC data.

In other words, the application server address is part of the FC data received by the S-CSCF from the HSS during subscriber registration phase. According to a network configuration, this address accesses a fixed AS node or randomly a node of a possible cluster of AS nodes.

According to FIG. 11, the S-CSCF receives the AS cluster as service_x address from the HSS and performs a node selection e.g. on the basis of a fixed upper layer subscriber related parameter. During this procedure, the S-CSCF may refer to a domain name server DNS. For example, the subscriber related parameter may be the calling user's Public Identity.

In FIG. 11, the node AS1 is selected, and the S-CSCF sends a third party register message to the selected node AS1 via an ISC (IMS Service Control) interface. During the third party registration phase the selected node AS1 fetches the subscriber's service_x data from the HSS via an Sh interface, and sends an acknowledgment message ‘200OK’ via the ISC interface back to the S-CSCF. The node AS1 will then be selected later on when the service_x is run.

With respect to load balancing in networks, there are two main load balancing principles, static and dynamic. The static load balancing is based on some information always existing when a server is to be selected, i.e. typically on a subscriber identity. Using this static method, transaction loads can be different due to some subscriber causing more transactions in the network.

The dynamic load balancing is based on some algorithm, e.g. round-robin or random algorithm, which can achieve a better load balancing of the servers. Using such algorithm, if all requests require substantially the same load, or if the dynamic load balancing can be augmented with a feedback of the load of the servers, a new request will be served by the less loaded server.

However, with the above node selection based on a fixed subscriber related parameter, no dynamic load sharing can be used. Moreover, in case the AS configuration is changed, also subscriber data have to be modified.

### SUMMARY OF THE INVENTION

It is therefore an object of the present invention to improve a serving entity selection in a registration procedure.

According to an embodiment of the invention, this object is achieved by a method of addressing a serving entity in a communication network, the method comprising the steps of:
sending a user registration message for a service to a serving entity group according to a service address, the serving entity group comprising a plurality of serving entities to support the service;
receiving an acknowledging message which acknowledges the sent user registration message and includes an address of a serving entity selected from the serving entity group for supporting the service; and
upon receiving the acknowledging message, including the address of the selected serving entity into an address table comprising service addresses and serving entity addresses.

Furthermore, the object is achieved by a control entity for addressing a serving entity in a communication network, the control entity comprising:
sending means for sending a user registration message for a service to a serving entity group according to a service address, the serving entity group comprising a plurality of serving entities to support the service;
receiving means for receiving an acknowldeging message which acknowledges the sent user registration message and includes an address of a serving entity selected from the serving entity group for supporting the service; and
including means for including the address of the selected serving entity into an address table comprising services address and serving entity addresses upon receiving the acknowledging message.

Moreover, the above object is achieved by a method of addressing a serving entity in a communication network, the method comprising the steps of:
receiving a user registration message for a service from a control entity at a serving entity group comprising a plurality of serving entities supporting the service;
selecting a serving entity from the plurality of serving entities for supporting the service;
including an address of the selected serving entity in a message acknowledging the received user registration message; and
sending the acknowledging message to the control entity.

Furthermore, the object is achieved by a serving entity for supporting a service in a communication network, the serving entity part of a serving entity group comprising a plurality of serving entities supporting the service, and receiving a user registration message for the service from a control entity, the serving entity comprising:
including means for including an address of a serving entity selected from the plurality of serving entities for supporting the service in a message acknowledging a received user registration message; and
sending means for sending the acknowledging message to a control entity.

Moreover, the above object is achieved by a method of addressing a serving entity in a communication network, the method comprising the steps of:
receiving a message for triggering a service from a control entity at a serving entity group comprising a plurality of serving entities supporting the service;
selecting a serving entity from the plurality of serving entities for supporting the service;
including an address of the selected serving entity in an error message rejecting the message for triggering the service; and
sending the error message to the control entity.

Furthermore, the object is achieved by a serving entity for supporting a service in a communication network, the serving entity part of a serving entity group comprising a plurality of serving entities supporting the service, and receiving a message for triggering a service from a control entity, the serving entity comprising:
including means for including an address of a serving entity selected from the plurality of serving entities for supporting the service in an error message rejecting the message for triggering the service; and
sending means for sending the error message to the control entity.

Furthermore, the above object is achieved by a computer program product comprising software code portions executing steps when said product is run on a computer for addressing a serving entity in a communication network, the steps comprising:
sending a user registration message for a service to a serving entity group according to a service address, the serving entity group comprising a plurality of serving entities to support the service; and
upon receiving a message which acknowledges the sent user registration message and includes an address of a serving entity selected from the serving entity group for supporting the service,including the address of the selected serving entity into an address table comprising service addresses and serving entity addresses.

Furthermore, the object is achieved by a system for transmitting from a serving entity to a control entity in a communication network, the system comprising:
a transmitter to transmit a signal comprising a message which acknowledges a received registration message and includes an address of a serving entity.

In addition, the above object is achieved by a network system comprising:
a control entity for addressing a serving entity in a communication network, the control entity including
   sending means for sending a user registration message for a service to a serving entity group according to a service address, the serving entity group comprising a plurality of serving entities to support the service;
   receiving means for receiving an acknowledging message acknowledging the sent registration message and including an address of the serving entity selected from the serving entity group for supporting the service; and
   including means for including the address of the selected serving entity in an address table comprising service addresses and serving entity addresses upon receiving the acknowledging message; and
a serving entity for supporting the service in the communication network, the serving entity part of the serving entity group comprising the plurality of serving entities supporting the service, and receiving the user registration message for the service from the control entity, the serving entity including
   including means for including an address of a serving entity selected from the plurality of serving entities for supporting the service in the message acknowledging the received user registration message and
   sending means for sending the acknowledging message to the control entity.

The node selection according to the present invention enables the use of dynamic load sharing including a network load sharing between network nodes as well as an internal load sharing in a cluster of nodes.

Moreover, in case a service address is used in FC data, the actual AS configuration can be changed without modifying subscriber data in HSS.

### BRIEF DESCRIPTION OF THE DRAWINGS

FIG. 1 shows a schematic block diagram of a communication network for addressing a serving entity according to the invention.

FIG. 2 shows a schematic block diagram illustrating a control entity and a serving entity according to the invention.

FIG. 3 shows a schematic block diagram of a part of an IMS network for addressing an application server according to a first embodiment of the invention.

FIG. 4 shows a signaling diagram illustrating signaling between IMS network components according to the first embodiment of the invention.

FIG. 5 shows a signaling diagram illustrating an example of AS load balancing according to the invention.

FIG. 6. shows a signaling diagram illustrating signaling between IMS network components in case of a user profile update according to a second embodiment of the invention.

FIG. 7 shows a signaling diagram illustrating signaling between IMS network components in case of a user profile update according to a third embodiment of the invention.

FIG. 8 shows a signaling diagram illustrating signaling between IMS network components in case of a user profile update according to a fourth embodiment of the invention.

FIGS. 9 and 10 show signaling diagrams illustrating signaling between IMS network components in case of a user profile update according to a fifth embodiment of the invention.

FIG. 11 shows a schematic block diagram of a part of an IMS network including signaling according to the prior art.

### DESCRIPTION OF THE INVENTION

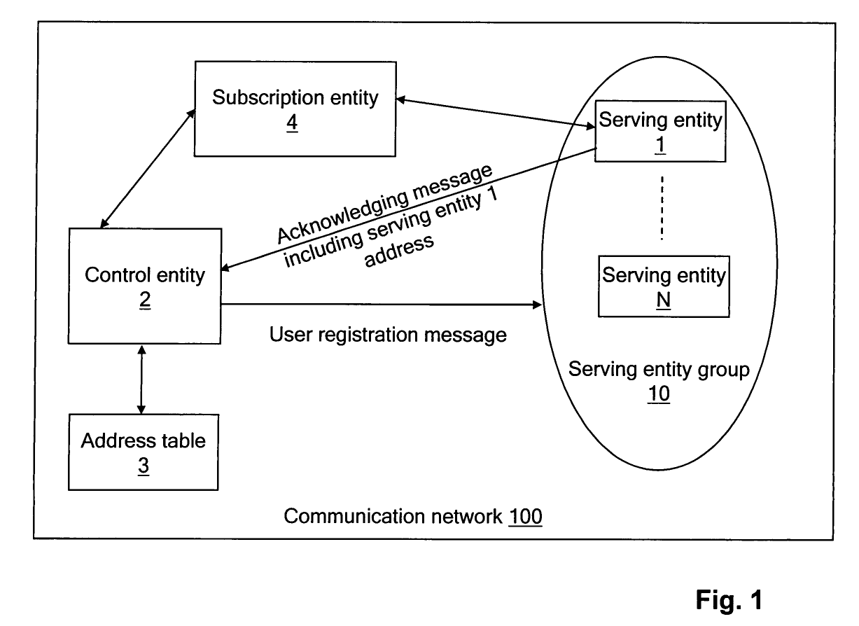

As shown in FIG. 1, a serving entity 1 such as an application server (AS) node for supporting a service in a communication network 100, e.g. an IP subsystem such as IMS, is part of a serving entity group or AS cluster 10 which comprises a plurality of serving entities or AS nodes 1 to N.

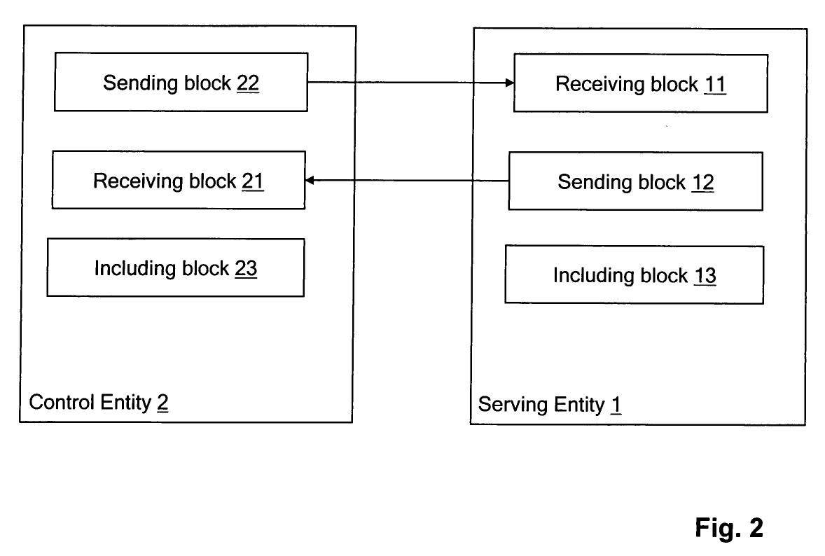

According to the invention, the serving entity group 10 is arranged to receive a user registration message for a service for a subscriber from a control entity 2 such as an S-CSCF, each of the plurality of serving entities 1 to N being arranged to support the service. For example, a serving entity 1 may receive the user registration message by means of a receiving block 11 as shown in FIG. 2. A serving entity, e.g. the serving entity 1, for supporting the service is selected out of the plurality of serving entities 1 to N. The selected serving entity 1 comprises an including block 13 for including the address of the serving entity 1 into a message acknowledging the received registration message and a sending block 12 for sending the acknowledging message back to the control entity 2.

The control entity 2 which has sent the user registration message for the service to the serving entity group 10 on the basis of a service address by means of a sending block 22, receives the message acknowledging the sent registration message and including the address of the selected serving entity 1 by means of a receiving block 21. Upon receipt of this message, the control entity 2 includes the address of the selected serving entity 1 into an address table 3 for the subscriber by means of an including block 23, the address table 3 comprising service addresses and serving entity addresses. Per subscriber an address table is provided. The control entity 2 may receive the service address from a subscription entity 4 such as an HSS (Home Subscriber Server).

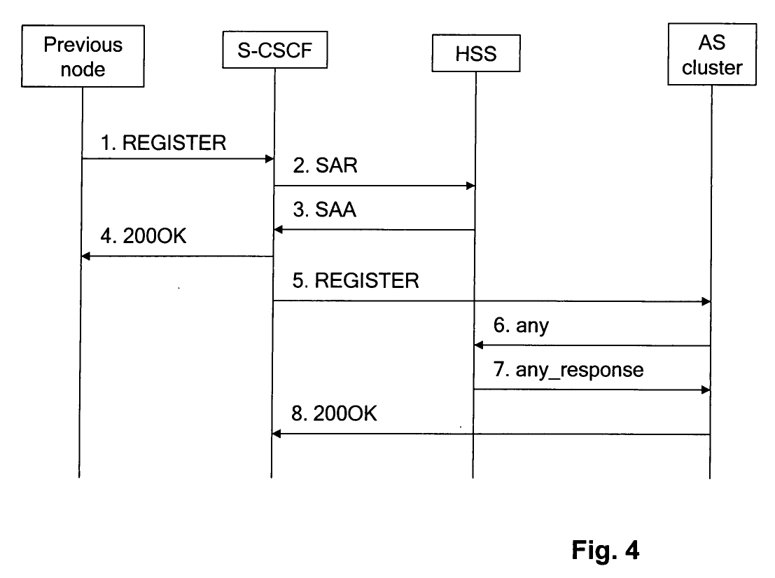

Upon triggering a service, the control entity 2 may refer to the address table 3 on the basis of a service address of the triggered service, the service address being received from the subscription entity 4, for example. In case the address table includes a serving entity address for the service to be triggered, the control entity 2 may use this serving entity address for triggering the service. In case the address table 3 does not include a serving entity address for the service to be triggered, the control entity 2 may use the service address for triggering the service as it is described in connection with FIG. 4.

According to the invention, a registration procedure such as a third party registration procedure in IMS can return the selected serving entity address back to the control entity 2. The control entity 2 saves the returned serving entity address to the address table 3 of the subscriber. In further triggering of services the control entity 2 uses the address table 3 to get the actual serving entity address.

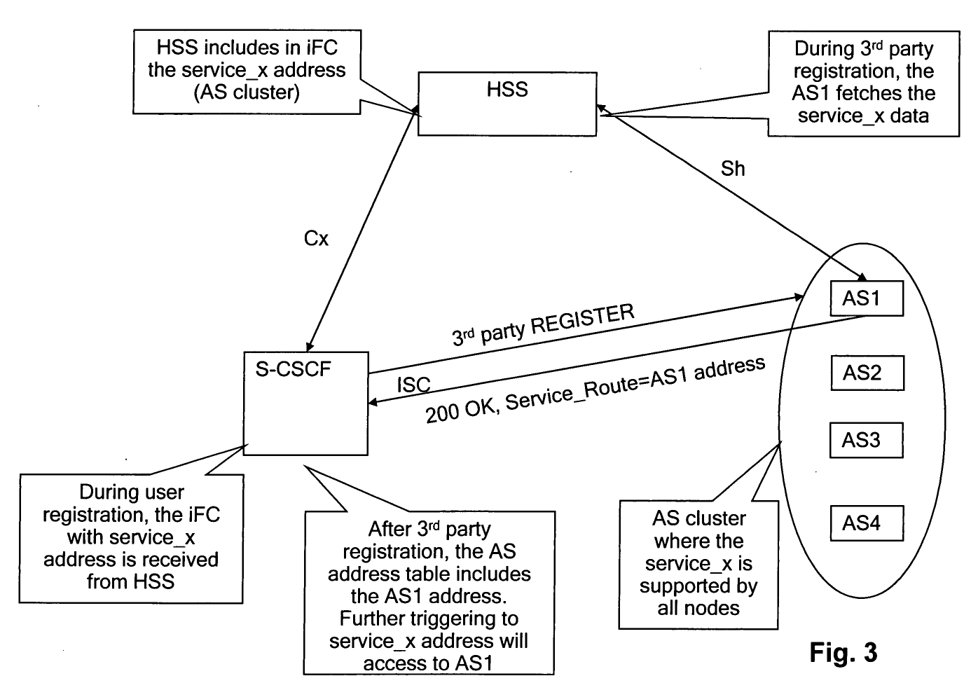

FIG. 3 shows an implementation example of the invention in an IMS environment. During subscriber registration, an S-CSCF (Serving Call State Control Function) receives FC data such as iFC (initial Filter Criterion) data via a Cx interface from an HSS (Home Subscriber Server), into which iFC data the HSS has included as service_x address for a requested service_x an address of an AS cluster supporting the service_x requested by the subscriber.

The S-CSCF sends a third party register message via an ISC (IMS Service Control) interface to the AS cluster indicated in the iFC data from the HSS. According to FIG. 3, an application server node AS1 is selected from the cluster for supporting the service. Thus, the node AS1 fetches service_x data via an Sh interface from the HSS during the third party registration, and returns its own node address in SIP (Session Initiation Protocol) response ‘200OK’ of the third party registration. Details about SIP can be found in J. Rosenberg et al.: “SIP: Session Initiation Protocol”, Network Working Group, RFC 3261, June 2002. The AS1 address may be included in Service Route or Contact header but is not restricted thereto. The address of the node AS1 may also be included into some other header.

After receiving the response message, the S-CSCF creates a new item in an AS address table of the subscriber and saves it to the subscriber data. Thus, the AS address table of the subscriber includes a connection between service addresses and AS node addresses. The address table may be located together with the subscriber data received from the HSS e.g. in a local subscription data repository in the S-CSCF.

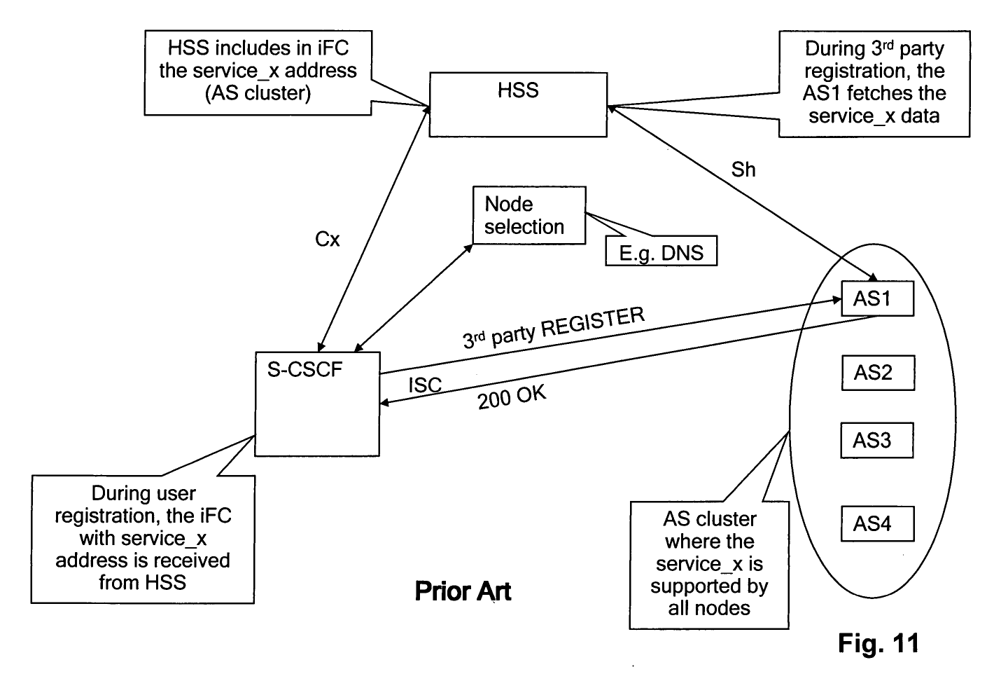

In further triggering on the basis of an FC of the subscriber, a service address obtained from the FC data of the subscriber is used to access the AS address table of the subscriber. In case there is an entry of an AS node address for the service address in the AS address table, the AS node address is used when the AS cluster is contacted. In case no match is found in the AS address table for the service address, the service address obtained from the FC data is used when the AS cluster is contacted, e.g. by using a subscriber related parameter as described in connection with FIG. 11.

According to FIG. 3, after the third party registration, the AS address table includes the AS1 address. Hence, a further triggering to the service_x address will provide an access to the node AS1.

FIG. 4 shows a signaling diagram illustrating signaling between the IMS network components shown in FIG. 3. In a communication 1, a user registration terminates at the S-CSCF from a previous node. In communications 2 and 3 (SAR: Server Assignment Request, SAA: Server Assignment Answer) the S-CSCF fetches user data from the HSS. The data includes the initial Filtering Criteria and the related AS cluster address. In a communication 4 the S-CSCF reports the success of the user registration to the previous node.

In a communication 5 the S-CSCF initiates a 3^{rd} party registration towards the AS cluster the address of which has been received from the HSS. In the AS cluster, an AS node is selected. The node selection is based on any method in the communication network or the AS cluster. In communications 6 and 7 the selected AS node fetches service data from the HSS using any supported protocol. Finally, in a communication 8, the selected AS node responses towards the S-CSCF. The selected AS node address is included in the response message.

As can be understood from the above, the invention allows more flexibility for IMS. When AS addresses are changed to be dynamic, SIP load-balancing can be implemented on AS side by existing mechanisms.

There may be many types of Application Servers (AS) connected to the IMS system, one example being a PoC (Push-to-talk-over-cellular, also know as PTT, Push-To-Talk) AS. IMS provides the AS capabilities that can be utilised to implement services for the subscribers. These capabilities include e.g. 3^{rd} party registration from IMS towards the AS.

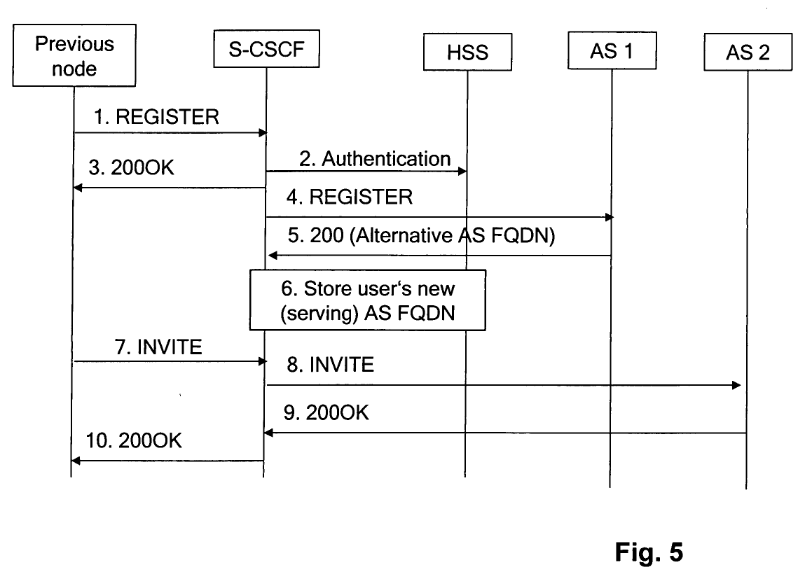

FIG. 5 shows a signaling diagram illustrating an example of AS load balancing according to the invention. When a user registers into services, e.g. PoC services, a first (provisioned) PoC AS 1 may return an alternative PoC AS FQDN (Fully Qualified Domain Name) (e.g. AS 2), which is to serve the user. In particular, in communication 1 in FIG. 5 a Register message is received by an S-CSCF. In communication 2 the S-CSCF performs authentication at an HSS of the user, i.e. it fetches user data from the HSS. The data includes the initial Filtering Criteria and an address of the provisioned PoC AS 1. In a communication 3 the S-CSCF reports the success of the user registration to the user via a previous node.

In a communication 4 the S-CSCF initiates a 3^{rd} party registration towards the PoC AS 1 the address of which has been received from the HSS. In a communication 5, the PoC AS 1 responses towards the S-CSCF with an acknowledging message indicating the alternative PoC AS FQDN, e.g. the address of the PoC AS 2.

After this, in block 6 the new FQDN is stored into IMS e.g. to subscriber's local data storage, in which the original (provisional) AS name (AS 1) is replaced with the new AS name (AS 2). This may effect e.g. on subscriber's filter criteria information. The locally stored information should be stored for the rest of registration lifetime. All the following (sub-) requests (communications 7, 8) should be routed to the alternative AS.

In case an operator updates subscriber's information during the registration lifetime (by an HSS/UMS initiated update of User Profile) it is possible that the FQDN of the alternative PoC AS is lost.

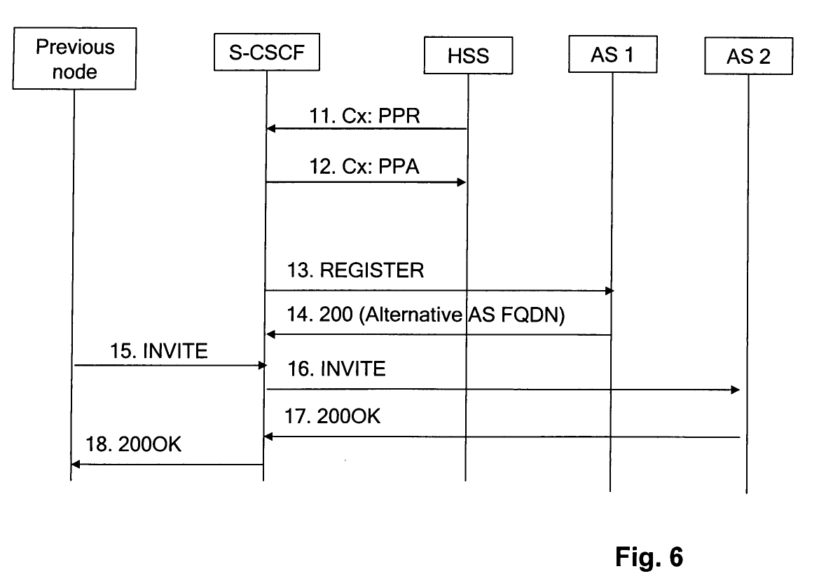

In the following, a second embodiment of the invention is described by referring to FIG. 6.

When the operator has updated the subscriber data in the HSS, in communication 11 following communication 10 in FIG. 5, the HSS reloads the information to the S-CSCF by a “Cx-Update_Subscr_Data” operation described in the Specification 3GPP TS 23.228. This procedure is mapped to a Push-Profile-Request (PPR) Diameter command described in the Specification 3GPP TS 29.229. The response Push-Profile-Answer (PPA) is sent to the HSS in communication 12 to confirm the successful update. After the update the IMS may check whether the update concerns the (special e.g. PoC) AS-subscribers.

In other words, the “HSS initiated update of User Profile” updates user profile information in the S-CSCF. This procedure corresponds to the functional level operation “Cx-Update_Subscr_Data” (see 3GPP TS 23.228). This procedure is mapped to the commands Push-Profile-Request/Answer in the Diameter application specified in 3GPP TS 29.229

The subscriber data update is done by the Push-Profile-Request (PPR) command (with Command-Code field set to 305 and the ‘R’ bit set in the Command Flags field) sent by a Diameter Multimedia server to a Diameter Multimedia client in order to update the subscription data of a multimedia user in the Diameter Multimedia client whenever a modification has occurred in the subscription data that constitutes the data used by the client.

The S-CSCF generates a new 3rd party registration notification (communication 13) according to earlier received registration data and an AS FQDN defined in the updated subscriber data.

It is important to take the AS from the updated data, since it is possible that the operator has changed it. Thus, the 3_{rd} party registration may be directed to the AS1 or it may be made directly to the AS 2 in case the operator has re-provisioned the subscriber to be served permanently by this node.

If the PoC AS returns SIP 200 “OK” (as shown in communication 14 in FIG. 6 the message may contain the (new) PoC AS 2 FQDN e.g. in Service-Route), all the following (sub-) requests (communications 15, 16) should be routed to the alternative AS like before the update. In case an error message is received by the S-CSCF in reply to the Invite message in communication 16, the operator's configuration has a mismatch with the current situation. Then the S-CSCF has to generate an alarm or an error log to indicate to the operator a configuration error.

According to the second embodiment as shown in FIG. 6, the IMS generates a new 3^{rd} party registration notification according to earlier received registration data and the AS FQDN defined in the updated subscriber data right after the subscriber data update.

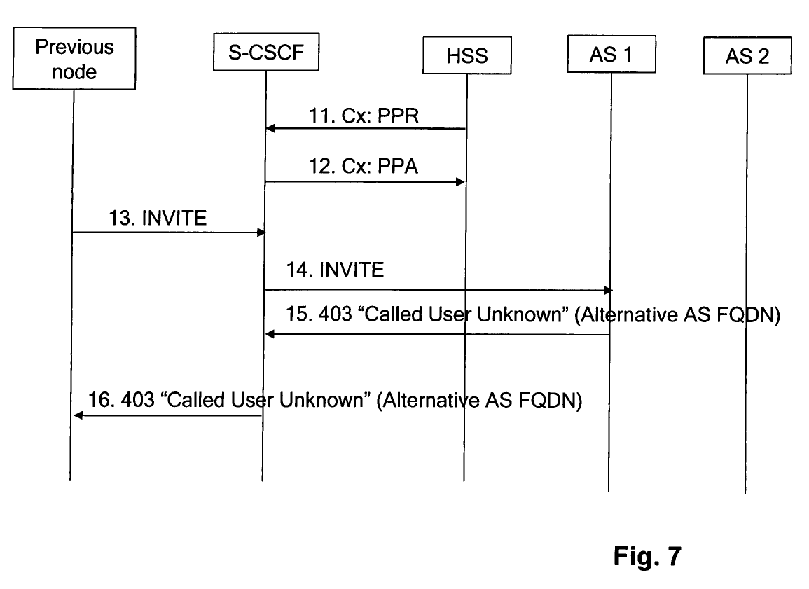

FIG. 7 shows a third embodiment of the invention. In communications 11 and 12, a subscriber data update is performed like in communications 11 and 12 in FIG. 6.

In case the IMS routes a SIP request from the user after the subscriber data update to the wrong PoC AS (to AS 1 instead of AS 2 as shown in FIG. 7), if the request is SIP REGISTER (as a re-registration), the PoC AS to which the S-CSCF routed the request returns SIP 200 “OK” with a correct PoC AS FQDN information stored e.g. into Service-Route. However, if the request is not SIP REGISTER but INVITE as shown in communications 13, 14 in FIG. 7, the PoC AS returns an appropriate error message (communication 15). The error message may contain a new PoC AS FQDN. The S-CSCF stores the received PoC AS FQDN to the subscriber's local data. As shown in communication 16 in FIG. 7, the S-CSCF may forward the error message to the user (with the received PoC AS FQDN).

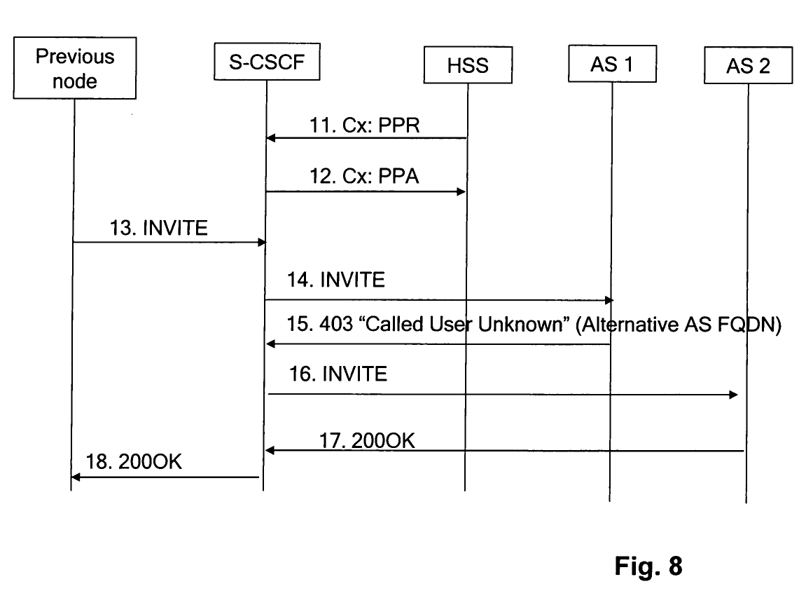

Alternatively, as shown in communications 16 to 18 in FIG. 8 illustrating a fourth embodiment of the invention, the S-CSCF may generate a new SIP INVITE message to the new PoC AS.

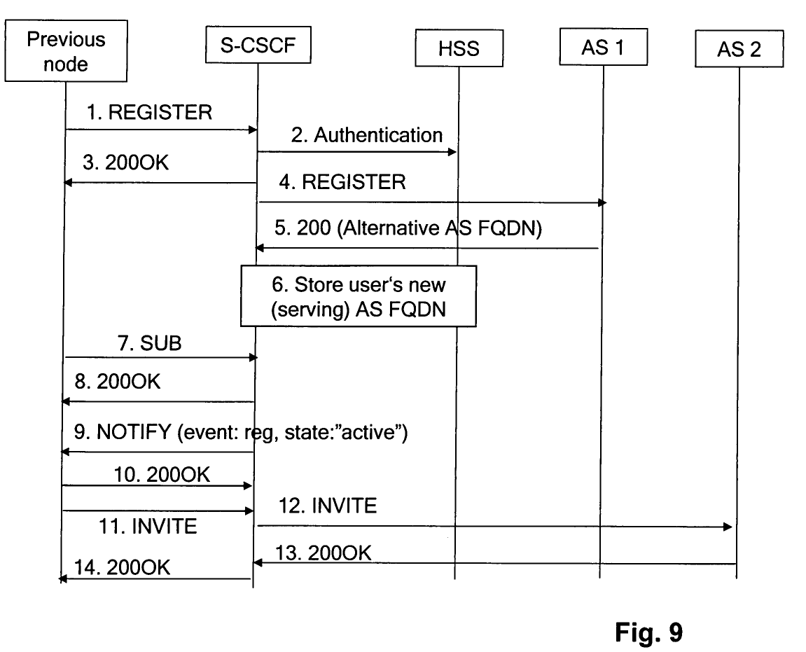

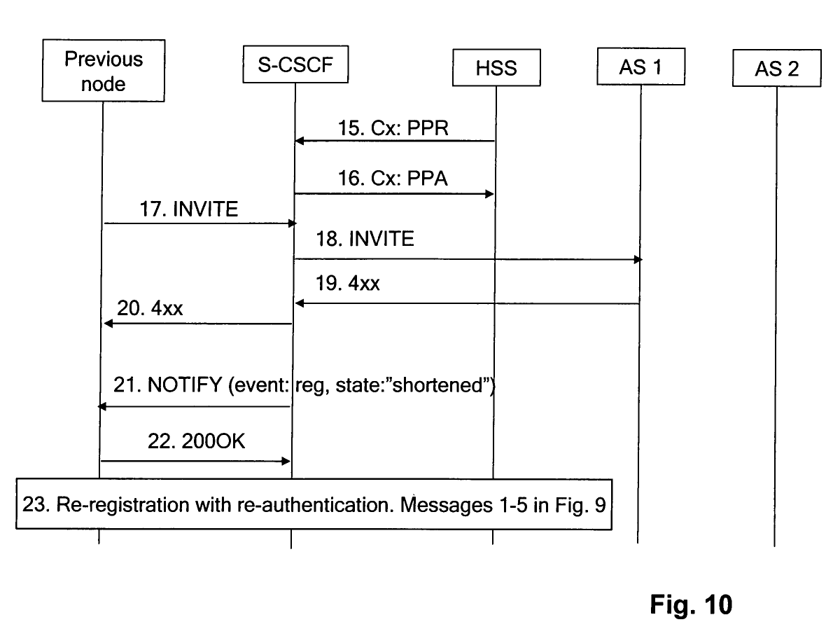

FIGS. 9 and 10 show a fifth embodiment of the invention. Besides the communications shown in FIG. 5, FIG. 9 further illustrates in communications 7 to 10 a SUBSCRIBE request and a NOTIFY request with corresponding acknowledging messages. Such requests are described by Sipping W G, J. Rosenberg in “A Session Initiation Protocol (SIP) Event Package for Registrations”, Internet Draft, Oct. 28, 2002. In this document, an event package and mechanisms therefore are introduced.

Referring to FIG. 10, after a subscriber data update in communications 15 and 16, in case the IMS routes a SIP request to a wrong PoC AS (AS 1 in FIG. 10) (communications 17 and 18 in FIG. 10), the PoC AS 1 returns an appropriate error message in communication 19. As a result to this specific error situation, the S-CSCF sends (e.g. according to received control information included in the PPR message (communication 15), which may be added into xml format part) a SIP NOTIFY message to the subscriber (event: “shortened”) via the previous node (communication 21) to inform the subscriber that a new registration and re-authentication is needed.

In a new registration procedure the AS FQDN updated by the operator is used in a new 3_{rd} party registration (communications 1 to 5 in FIG. 9 with updated AS FQDN). As a result the local information of subscriber's serving-AS is (re-) updated if needed. Any existing SIP sessions between the user and the PoC AS remain.

In the above described embodiments PoC services are used as example of usage. However, it is to be understood that the invention is not limited to PoC services but can be applied to any IMS application services.

It is to be understood that the above description is illustrative of the invention and is not to be construed as limiting the invention. Various modifications and applications may occur to those skilled in the art without departing from the true spirit and scope of the invention as defined by the appended claims.

1. A method of addressing a serving entity in a communication network, the method comprising the steps of:
sending a user registration message for a service to a serving entity group according to a service address, the serving entity group comprising a plurality of serving entities to support the service;
receiving an acknowledging message which acknowledges the sent user registration message and includes an address of a serving entity selected from the serving entity group for supporting the service; and
upon receiving the acknowledging message, including the address of the selected serving entity into an address table comprising service addresses and serving entity addresses.

2. The method according to claim 1, further comprising the steps of:
referring to the address table using the service address upon triggering the service; and
using the serving entity address for triggering the service if the address table includes the serving entity address to trigger the service.

3. The method according to claim 2, further comprising the step of:
using the service address for triggering the service if the address table does not include the serving entity address to trigger the service.

4. The method according to claim 1, further comprising the step of:
receiving the service address from a subscription entity.

5. The method according to claim 1, further comprising providing the address table per subscriber.

6. The method according to claim 1, comprising the steps of:
detecting an update of the service address; and
upon detecting the update, re-sending the user registration message for the service to the serving entity group according to the updated service address.

7. The method according to claim 2, comprising the steps of:
receiving an error message in response to triggering the service, the error message including an address of another serving entity selected from the serving entity group for supporting the service; and
forwarding the error message to a user.

8. The method according to claim 2, comprising the steps of:
receiving an error message in response to triggering the service, the error message including an address of another serving entity selected from the serving entity group for supporting the service; and
using the another serving entity address for triggering the service.

9. The method according to claim 2, comprising the steps of:
receiving an error message in response to triggering the service; and
sending a notifying message to a user upon receiving the error message.

10. A method of addressing a serving entity in a communication network, the method comprising the steps of:
receiving a user registration message for a service from a control entity at a serving entity group comprising a plurality of serving entities supporting the service;
selecting a serving entity from the plurality of serving entities for supporting the service;
including an address of the selected serving entity in a message acknowledging the received user registration message; and
sending the acknowledging message to the control entity.

11. A method of addressing a serving entity in a communication network, the method comprising the steps of:
receiving a message for triggering a service from a control entity at a serving entity group comprising a plurality of serving entities supporting the service;
selecting a serving entity from the plurality of serving entities for supporting the service;
including an address of the selected serving entity in an error message rejecting the message for triggering the service; and
sending the error message to the control entity.

12. A computer program product comprising software code portions executing steps when said product is run on a computer for addressing a serving entity in a communication network, the steps comprising:
sending a user registration message for a service to a serving entity group according to a service address, the serving entity group comprising a plurality of serving entities to support the service; and
upon receiving a message which acknowledges the sent user registration message and includes an address of a serving entity selected from the serving entity group for supporting the service,including the address of the selected serving entity into an address table comprising service addresses and serving entity addresses.

13. The computer program product according to claim 12, further comprising a computer-readable medium on which the software code portions are stored.

14. The computer program product according to claim 12, wherein the computer program product is directly loadable into an internal memory of the computer.

15. A system for transmitting from a serving entity to a control entity in a communication network, the system comprising:
a transmitter to transmit a signal comprising a message which acknowledges a received registration message and includes an address of a serving entity.

16. A control entity for addressing a serving entity in a communication network, the control entity comprising:
sending means for sending a user registration message for a service to a serving entity group according to a service address, the serving entity group comprising a plurality of serving entities to support the service;
receiving means for receiving an acknowldeging message which acknowledges the sent user registration message and includes an address of a serving entity selected from the serving entity group for supporting the service; and
including means for including the address of the selected serving entity into an address table comprising services address and serving entity addresses upon receiving the acknowledging message.

17. The control entity according to claim 16, further comprising:
referring means for referring to the address table according to the service address upon triggering a service; and
using means for using the serving entity address for triggering the service if the address table includes the serving entity address to trigger the service.

18. The control entity according to claim 17, further comprising:
using means for using the service address for triggering the service if the address table does not include the serving entity address to trigger the service.

19. The control entity according to claim 16, further comprising:
receiving means for receiving the service address from a subscription entity.

20. The control entity according to claim 16, comprising:
detecting means for detecting an update of the service address, wherein the sending means are configured to re-send the user registration message for the service to the serving entity group according to the updated service address upon detecting the update.

21. The control entity according to claim 17, wherein
the receiving means are configured to receive an error message in response to triggering the service, the error message including an address of another serving entity selected from the serving entity group for supporting the service; and
the sending means are configured to forward the error message to a user.

22. The control entity according to claim 17, wherein the receiving means are configured to receive an error message in response to triggering the service, the error message including an address of another serving entity selected from the serving entity group for supporting the service; and
the using means are configured to use the another serving entity address for triggering the service.

23. The control entity according to claim 17, wherein the receiving means are configured to receive an error message in response to triggering the service; and
the sending means are configured to send a notifying message to a user upon receipt of the error message by the receiving means.

24. A serving entity for supporting a service in a communication network, the serving entity part of a serving entity group comprising a plurality of serving entities supporting the service, and receiving a user registration message for the service from a control entity, the serving entity comprising:
including means for including an address of a serving entity selected from the plurality of serving entities for supporting the service in a message acknowledging a received user registration message; and
sending means for sending the acknowledging message to a control entity.

25. A serving entity for supporting a service in a communication network, the serving entity part of a serving entity group comprising a plurality of serving entities supporting the service, and receiving a message for triggering a service from a control entity, the serving entity comprising:
including means for including an address of a serving entity selected from the plurality of serving entities for supporting the service in an error message rejecting the message for triggering the service; and
sending means for sending the error message to the control entity.

26. A network system comprising:
a control entity for addressing a serving entity in a communication network, the control entity including
sending means for sending a user registration message for a service to a serving entity group according to a service address, the serving entity group comprising a plurality of serving entities to support the service;
receiving means for receiving an acknowledging message acknowledging the sent registration message and including an address of the serving entity selected from the serving entity group for supporting the service; and
including means for including the address of the selected serving entity in an address table comprising service addresses and serving entity addresses upon receiving the acknowledging message; and
a serving entity for supporting the service in the communication network, the serving entity part of the serving entity group comprising the plurality of serving entities supporting the service, and receiving the user registration message for the service from the control entity, the serving entity including
including means for including an address of a serving entity selected from the plurality of serving entities for supporting the service in the message acknowledging the received user registration message and
sending means for sending the acknowledging message to the control entity.
